(19) United States
(12) Patent Application Publication
(10) Pub. No.: US 2023/0250544 A1
(43) Pub. Date: Aug. 10, 2023

(54) NANOPOROUS MEMBRANE SUPPORT IN AN ELECTROLYZER CELL

(71) Applicant: Verdagy, Inc., Moss Landing, CA (US)

(72) Inventors: THOMAS H. McWaid, Santa Cruz, CA (US); Shizhao su, Marina, CA (US)

(21) Appl. No.: 18/166,340

(22) Filed: Feb. 8, 2023

Related U.S. Application Data
(60) Provisional application No. 63/267,694, filed on Feb. 8, 2022.

(51) Int. Cl. C25B 13/08

(52) U.S. Cl. CPC C25B 13/08

(57) ABSTRACT

An electrolyzer cell comprises a first half cell with a first electrode, a second half cell with a second electrode, a separator separating the first half cell from the second half cell, wherein a compressive load is applied between the separator and the first electrode or between the separator and the second electrode, or between both the first and second electrodes and the separator, and a nanoporous support structure located between the first electrode and the separator.

### CROSS-REFERENCE TO RELATED APPLICATION

This application claims priority under 35 U.S.C. § 119(e) to U.S. Provisional Application Ser. No. 63/267,694, filed on Feb. 8, 2022, entitled “NANOPOROUS MEMBRANE SUPPORT IN AN ELECTROLYZER CELL,” the disclosure of which is incorporated herein by reference in its entirety.

### BACKGROUND

The production of hydrogen can play an important role because hydrogen gas is required for many chemical processes. As of 2019, roughly 70 million tons of hydrogen is produced annually worldwide for various uses, such as oil refining, in the production of ammonia (through the Haber process), in the production of methanol (though reduction of carbon monoxide), or as a fuel in transportation.

Historically, a large majority of hydrogen (˜95%) has been produced from fossil fuels (e.g., by steam reforming of natural gas, partial oxidation of methane, or coal gasification). Other methods of hydrogen production include biomass gasification, low- or no-CO₂ emission methane pyrolysis, and electrolysis of water. Electrolysis uses electricity to split water molecules into hydrogen gas and oxygen gas. To date, electrolysis systems and methods have been generally more expensive than fossil-fuel based production methods. However, the fossil-fuel based methods can be more environmentally damaging, generally resulting in increased CO₂ emissions. Therefore, there is a need for cost-competitive and environmentally-friendly methods of hydrogen gas producing electrolysis systems and methods.

### SUMMARY

The present disclosure describes an electrolyzer cell comprising a first half cell with a first electrode, a second half cell with a second electrode, a separator separating the first half cell from the second half cell, wherein a compressive load is applied between the separator and the first electrode or between the separator and the second electrode, or between both the first and second electrodes and the separator, and a first nanoporous support structure located between the first electrode and the separator.

The present disclosure also describes a method of manufacturing an electrolyzer cell, the method comprising providing or receiving a first electrode, a second electrode, and a separator, positioning a first nanoporous support structure between the first electrode and the separator, positioning the second electrode relative to the separator, and applying a compressive load between the separator and the first electrode, or between the separator and the second electrode, or between both the first and second electrodes and the separator.

### BRIEF DESCRIPTION OF THE FIGURE

The drawing illustrates generally, by way of example, but not by way of limitation, various embodiments discussed in the present document.

FIG. 1 is a schematic diagram of an example electrolyzer cell for the electrolysis of water to produce hydrogen gas, including a nanoporous support structures that support or protect the separator from mechanical force exerted by one or both electrodes due to compressive load exerted onto one or both electrodes in the electrolyzer cell.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1”” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Hydrogen gas (H₂) can be formed electrochemically by a water-splitting reaction where water is split into oxygen gas (O₂) and H₂ gas at an anode and a cathode of an electrochemical cell, respectively. Examples of such electrochemical processes include, without limitation, proton electrolyte membrane (PEM) electrolysis and alkaline water electrolysis (AWE). In such electrochemical reactions, the operating energy necessary to drive the water-splitting electrolysis reaction is high due to additional energy costs as a result of various energy inefficiencies. For example, to reduce unwanted migration of ionic species between the electrodes, the cathode and the anode may be separated by a separator, such as a membrane, which can reduce migration of the ionic species. Although the separator can improve the overall efficiency of the cell, it can come at a cost of additional resistive losses in the cell, which in turn increases the operating voltage. Other inefficiencies in water electrolysis can include solution resistance losses, electric conduction inefficiencies, and/or electrode over-potentials, among others.

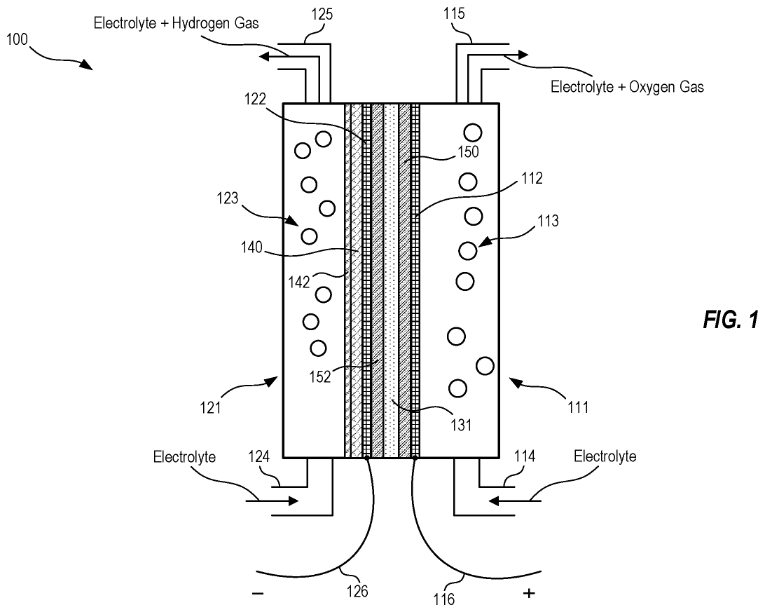

FIG. 1 is a schematic diagram of a generic water electrolyzer cell 100 that converts water (H₂O) into hydrogen gas (H₂) and oxygen gas (O₂) with electrical power is illustrated in FIG. 1. In an example, the electrolyzer cell 100 comprises two half cells: a first half cell 111 and a second half cell 121. In an example, the first and second half cells 111, 121 are separated by a separator 131, such as a membrane 131. In an example, the separator 131 comprises a porous membrane (e.g., a microporous membrane or a nanoporous membrane), an ion-exchange membrane, or an ion solvating membrane. In examples wherein the separator 131 comprises an ion-exchange membrane, the membrane can be of different types, such as an anion exchange membrane (AEM), a cation exchange membrane (CEM), a proton exchange membrane (PEM), or a bipolar ion exchange membrane (BEM).

In examples where the separator 131 is a cation exchange membrane, the cation exchange membrane can be a conventional membrane such as those available from, for example, Asahi Kasei Corp. of Tokyo, Japan, or from Membrane International Inc. of Glen Rock, N.J., USA, or from The Chemours Company of Wilmington, Del., USA. Examples of cation exchange membranes include, but are not limited to, the membrane sold under the N2030WX trade name by The Chemours Company and the membrane sold under the F8020/F8080 or F6801 trade names by the Asahi Kasei Corp. Examples of materials that can be used to form a cationic exchange membrane include, but are not limited to, a perfluorinated polymer containing anionic groups, for example sulphonic and/or carboxylic groups. It may be appreciated, however, that in some examples, depending on the need to restrict or allow migration of a specific cation or an anion species between the electrolytes, a cation exchange membrane that is more restrictive and thus allows migration of one species of cations while restricting the migration of another species of cations may be used. Similarly, in some embodiments, depending on the need to restrict or allow migration of a specific anion species between the electrolytes, an anion exchange membrane that is more restrictive and thus allows migration of one species of anions while restricting the migration of another species of anions may be used. Such restrictive cation exchange membranes and anion exchange membranes are commercially available and can be selected by one ordinarily skilled in the art.

In some examples, the separator 131 can be selected so that it can function in an acidic and/or an alkaline electrolytic solution, as appropriate. Other properties for the separator 131 that may be desirable include, but are not limited to, high ion selectivity, low ionic resistance, high burst strength, and high stability in electrolytic solution in a temperature range of room temperature to 150° C. or higher.

In an example, the separator 131 is stable in a temperature range of from about 0° C. to about 150° C., for example from about 0° C. to about 100° C., such as from about 0° C. to about 90° C., for example from about 0° C. to about 80° C., such as from about 0° C. to about 70° C., for example from about 0° C. to about 60° C., such as from about 0° C., to about 50° C., for example from about 0° C. to about 40° C., or such as from about 0° C. to about 30° C.

It may be useful to use an ion-specific ion exchange membrane that allows migration of one type of ion (e.g., cation for a CEM and anion for an AEM) but not another, or migration of one type of ion and not another, to achieve a desired product or products in the electrolyte solution.

In an example, the first half cell 111 comprises a first electrode 112, which can be positioned proximate to the separator 131, and the second half cell 121 comprises a second electrode 122, which can be positioned proximate to the separator 131, for example on an opposite side of the separator 131 from the first electrode 112. In an example, the first electrode 112 is the anode for the electrolyzer cell 100 and the second electrode 122 is the cathode for the electrolyzer cell 100, such that for the remainder of the present disclosure the first half cell 111 may also be referred to as the anode half cell 111, the first electrode 112 may also be referred to as the anode 112, the second half cell 121 may also be referred to as the cathode half cell 121, and the second electrode 122 may also be referred to as the cathode 122. Each of the electrodes 112, 122 can be coated with one or more electrocatalysts to speed the reaction toward the hydrogen gas (H₂ gas) and/or the oxygen gas (O₂ gas). Examples of electrocatalysts include, but are not limited to, highly dispersed metals or alloys of platinum group metals, such as platinum, palladium, ruthenium, rhodium, iridium, or their combinations such as platinum-rhodium, platinum-ruthenium, a nickel mesh coated with ruthenium oxide (RuO₂), or a high-surface area nickel.

In an example, the anode 112 is electrically connected to an external positive conductor 116 (also referred to as “the anode conductor 116”) and the cathode 122 is electrically connected to an external negative conductor 126 (also referred to as “the cathode conductor 126”). When the separator 131 is wet and is in electrolytic contact with the electrodes 112 and 122, and an appropriate voltage is applied across the conductors 116 and 126, O₂ gas is liberated at the anode 112 and H₂ gas is liberated at the cathode 122. In certain configurations, an electrolyte, e.g., one comprising of a solution of KOH in water, is fed into the half cells 111, 121. For example, the electrolyte can flow into the anode half cell 111 through a first electrolyte inlet 114 and into the cathode half cell 121 through a second electrolyte inlet 124. In an example, the flow of the electrolyte through the anode half cell 111 picks up the produced O₂ gas as bubbles 113, which exits the anode half cell 111 through a first outlet 115. Similarly, the flow of the electrolyte through the cathode half-cell 121 can pick up the produced H₂ gas as bubbles 123, which can exit the cathode half cell 121 through a second outlet 125. The gases can be separated from the electrolyte downstream of the electrolyzer cell 100 with one or more appropriate separators. In an example, the produced H₂ gas is dried and harvested into high pressure canisters or fed into further process elements. The O₂ gas can be allowed to simply vent into the atmosphere or can be stored for other uses. In an example, the electrolyte is recycled back into the half cells 111, 121 as needed.

In an example, a typical voltage across the electrolyzer cell 100 (e.g., the voltage difference between the anode conductor 116 and the cathode conductor 126) is from about 1.5 volts (V) to about 3.0 V. In an example, an operating current density for the electrolyzer cell 100 is from about 0.1 A/cm2 to about 3 A/cm2. Each cell 100 has a size that is sufficiently large to produce a sizeable amount of H₂ gas when operating at these current densities. In an example, a cross-sectional area of each cell 100 (e.g., a width multiplied by a height for a rectangular cell) is from about 0.25 square meters (m²) to about 15 m², such as from about 1 m² to about 5 m², for example from about 2 m² to about 4 m², such as from about 2.25 m² to about 3 m², such as from about 2.5 m² to about 2.9 m². In an example, the total volume of each cell (e.g., a width multiplied by a height multiplied by a depth) is from about 0.1 cubic meter (m³) to about 2 m³, such as from about 0.15 m³ to about 1.5 m³, for example from about 0.2 m³ to about 1 m³, such as from about 0.25 m³ to about 0.5 m³, for example from about 0.275 m³ to about 0.3 m³. In an example, the total volume of the entire electrolyzer system (e.g., the combined volume of all the cells in all the stacks in the plant) is from about 1 m³ to about 25,000 m³, such as from about 5 m³ to about 2,500 m³, for example from about 10 m³ to about 100 m³, such as from about 25 m³ to about 75 m³, for example from about 30 m³ to about 50 m³.

The ohmic resistance of the separator 131 can affect the voltage drop across the anode 112 and the cathode 122. For example, as the ohmic resistance across the separator 131 increases, the voltage across the anode 112 and the cathode 122 may increase, and vice versa. In an example, the separator 131 has a relatively low ohmic resistance and a relatively high ionic mobility. In an example, the separator 131 has a relatively high hydration characteristics that increase with temperature, and thus decreases the ohmic resistance. By selecting a separator 131 with lower ohmic resistance known in the art, the voltage drop across the anode 112 and the cathode 122 at a specified temperature can be lowered.

The efficiency of the electrolyzer cell 100 can depend on resistive losses between the anode 112 and the cathode 122. One parameter that can affect the ohmic resistance between the electrodes 112, 122 is the distance between the anode 112 and the cathode 122. A larger gap between the electrodes 112, 122 results in a correspondingly larger resistance compared to a smaller gap. Therefore, in an example, the electrolyzer cell 100 can be configured so that the space or gap between the anode 112 and the cathode 122 is as small as possible. In one example configuration, one or both of the anode 112 and the cathode 122 are positioned so that the electrode 112, 122 is in contact with the separator 131, which is also referred to as a “zero-gap” configuration. In an example of a zero gap configuration, one face or surface of the anode 112 is in contact with a first surface of the separator 131 and one face or surface of the cathode 122 is in contact with an opposing second surface of the separator 131.

In an example, a zero-gap configuration can be accomplished by positioning an elastic element adjacent to one or both of the electrodes 112, 122. In an example, the elastic element comprises a compressible and expandable structure that provides a controlled compressive load when compressed by a specified amount. The overall structure of the anode 112, the separator 131, the cathode 122, and the elastic element can be compressed, for example between support structures or a housing of the electrolyzer cell 100, which generates a load as the elastic element tries to expand back to its fully expanded position that acts to load the electrode 112, 122 against the separator 131 to provide a zero-gap configuration. In an example, the elastic element comprises a corrugated knitted mesh structure. In an example, the elastic element comprises one or more electrically conductive structures so that current can flow through the elastic element and into or out of the electrode 112, 122 onto which the elastic element is compressed.

In an example, the elastic element comprises one or more electrically conductive filaments that are woven together into an elastic layer that can expand and collapse to apply the controlled compressive load when the elastic layer is compressed. In some examples, the elastic element is a corrugated knitted mesh having a pre-load of about 2 pounds per square inch at about 3 mm of compression. In an example, an uncompressed thickness of the elastic element is from about 5 mm to about 7 mm. The elastic element can have a corrugation pitch of about 10 mm. In an example, the elastic element is formed from wire having a wire diameter of about 0.15 mm.

In the example shown in FIG. 1, an elastic element 140 is included only on the cathode-side of the separator 131 such that a loading force is only applied by the elastic element 140 against the cathode 122, which compresses the cathode 122 into the separator 131. The loading force exerted by the elastic element 140 can be sufficient so that it also generates a loading force between the separator 131 and the anode 112, e.g., by pushing the separator 131 into the anode 112. Those having skill in the art will appreciate that an elastic element could be included on the anode-side of the separator 131 in addition to or in place of the cathode-side elastic element 140 shown in FIG. 1. In the example shown, the electrolyzer cell 100 includes a cell support 142 on the back side of the elastic element 140, and the elastic element 140 is compressed between the cell support 142 and the cathode 122. The cell support 142 can be coupled to the housing or chassis of the electrolyzer cell 100. For example, the cell support 142 can be a current collector and current can flow between the cell housing and the current collector 142.

In an example, a differential fluid pressure can be applied across the separator 131 (e.g., with a pressure on the cathode side of the separator 131 being larger than on the anode side, or vice versa). The differential pressure, in addition to the elastic element 140 can act to load the electrodes 112, 122 and create effective electrical contact across the active area of the electrodes 112, 122, particularly with fine mesh electrodes.

As will be appreciated by those having skill in the art, one or both of the electrodes 112, 122 can include structures that can result in mechanical wear and eventual damage to the separator 131 when the electrodes 112, 122 are loaded onto the separator 131. For example, one or both electrodes 112, 122 can include raised structures that, when loaded onto the separator 131, can project into the material of the separator 131 and over time can wear away and damage the separator 131. One type of structure that can be used as one or both of the electrodes 112, 122 is a fine woven mesh, which can comprise a network of sets of crossing wires, which can be perpendicular or angled relative to one another, that alternative cross and bend over one another. For example, any particular wire alternates between passing under an adjacent cross wire and then over the next cross wire. In an example, one or both of the electrodes 112, 122 can comprise a woven wire mesh electrode formed from wires having a wire diameter of about 0.18 mm diameter with openings in the mesh of about 0.44 mm and with an open area of from about 50% to about 60%, such as from about 50% to about 55%. In an example, one or both of the electrodes 112, 122 is formed from an expanded mesh wherein one or both of the electrodes 112, 122 are fabricated from a sheet of material that is about 0.13 mm thick with a long way of the diamond shape (LWD) of about 2 mm and a short way of the diamond (SWD) of about 1 mm.

Often, when wire mesh structures are used as one or both of the electrodes 112, 122, the electrode 112, 122 will contact the separator 131 where an apex is formed where a wire of the woven mesh overlaps another wire. Relatively high local contact stress can result at the apex contact points between the woven mesh electrode 112, 122 and the separator 131 if they are allowed to be in direct contact. In particular, a separator 131 that is very thin, e.g., that is 100 micrometer (μm) or less, can be more readily punctured or otherwise damaged by loaded contact between the wire apexes of the electrodes 112, 122 and the separator 131. In addition, the loading force of the elastic element 140 and/or a differential pressure between the anode-side and the cathode-side of the separator 131 can generate stress on the separator 131, which can cause portions of the separator 131 to be stretched into open spaces of the electrode 112, 122, such as gaps between wires in a woven mesh electrode 112, 122. The stretched separator 131, in addition to wire apexes or other raised electrode structures being compressed against the separator 131, can eventually result in the creation of local thin spots or punctures in the separator 131.

In an example, the electrolyzer cell 100 can include one or more separator support structures located between the anode 112 and the separator 131, between the cathode 122 and the separator 131, or both between the anode 112 and the separator 131 and between the cathode 122 and the separator 131. The one or more separator support structures can be compressed between the separator 131 and the corresponding electrode 112, 122 and can act to provide mechanical protection for the separator 131 to mitigate or minimize the mechanical stresses between the electrodes 112, 122 and the separator 131 described above. In the example shown in FIG. 1, the electrolyzer cell 100 includes a first separator support structure 150 located between the anode 112 and the separator 131 (also referred to as “the anode-side support structure 150”) and a second separator support structure 152 located between the cathode 122 and the separator 131 (also referred to as “the cathode-side support structure 152”).

In an example, the one or more separator support structures 150, 152 can comprise one or more nanoporous support sheets positioned between the anode 112 and the separator 131, between the cathode 122 and the separator 131, or both between the anode 112 and the separator 131 and between the cathode 122 and the separator 131. For example, the anode-side support structure 150 can comprise an anode-side nanoporous support sheet 150 positioned between the anode 112 and the separator 131 and the cathode-side support structure 152 can comprise a cathode-side nanoporous support sheet 152 positioned between the cathode 122 and the separator 131.

Each nanoporous support sheet 150, 152 can comprise a porous body with pores, wherein at least a portion of the pores extend throughout the entire body from one face of the nanoporous support sheet 150, 152 to the opposing face. In an example, the pores are configured so that electrolyte solution can pass through the nanoporous support sheet 150, 152 so that there is an electrolyte path between the separator 131 and the electrode 112, 122 from which the nanoporous support sheet 150, 152 is protecting the separator 131. In an example, at least a portion of the surfaces of the nanoporous support sheet 150, 152 that will be exposed to the electrolyte solution are hydrophilic so that the surfaces of the nanoporous support sheet 150, 152 will be effectively wetted by the electrolyte solution as it flows through the electrolyzer cell 100. If the surfaces of the nanoporous support sheet 150, 152 do not sufficiently wet, then the electrolyte solution may not efficiently pass through the nanoporous support sheet 150, 152, which can result in increased resistance across the separator 131. Hydrophilic surfaces wet readily when contacted with an alkaline solution, such as the alkaline electrolyte solution (e.g., KOH) that can be used in the electrolyzer cell 100.

One or both of the nanoporous support sheets 150, 152 can be made from a hydrophilic material that forms the main body of the nanoporous support sheet 150, 152. For example, the main body of the nanoporous support sheets 150, 152 can be made from an inherently hydrophilic polymer, such as polyethersulfone (PES). In some examples, the main body of the nanoporous support sheets 150, 152 can be made from a polymer blend comprising both a hydrophilic polymer and a hydrophobic polymer or from a copolymer comprising both hydrophilic and hydrophobic polymer blocks. Including hydrophobic components (either in the form of a polymer blend that includes a hydrophobic polymer or a copolymer with hydrophobic blocks) can make fabrication of the nanoporous support sheets 150, 152 easier, such as by lowering the phase transition temperature for the polymer that forms the nanoporous support sheets 150, 152 and/or to strengthen mechanical properties of the nanoporous support sheets 150, 152. In other examples, the main body of the nanoporous support sheet 150, 152 can be made from a non-hydrophilic material, such as a hydrophobic polymer, which is surface treated to produce hydrophilicity on at least a portion of the surfaces of the nanoporous support sheet 150, 152. Surface treatment can also be applied to inherently hydrophilic materials. Examples of surface treatments that can be used on the nanoporous support sheets 150, 152 include, but are not limited to, plasma irradiation, ultraviolet light irradiation, corona discharge, ion assisted reaction (IAR), or the application of a hydrophilic coating.

In an example, the main body of one or both of the nanoporous support sheets 150, 152 comprises a polymer material, such as a hydrophilic polymer, a hydrophobic polymer (which can be surface treated to provide hydrophilicity, as described above), a polymer blend comprising both a hydrophilic and a hydrophobic polymer, or a copolymer comprising one or more hydrophilic blocks and one or more hydrophobic blocks. Examples of polymers that can be used to form one or both of the nanoporous support sheets 150, 152 include, but are not limited to, polytetrafluoroethylene (PTFE), polypropylene (PP), polyethersulfone (PES), polyphenylene sulfide (PPS), and polyphenyl sulfone (PPSU).

As will be appreciated by those having skill in the art, a significant volume of gas is produced in the electrolyzer cell 100, e.g., H₂ gas at the cathode 122 and O₂ gas at the anode 112. Ion exchange through the nanoporous support sheets 150, 152 and the separator 131 can be hindered if the pores of the nanoporous support sheets 150, 152 fill with, and remain full of, this gas. Therefore, in an example, one or both of the nanoporous support sheets 150, 152 are configured to avoid, minimize, or reduce permeation of gas through the nanoporous support sheet 150, 152. It has been found that gas permeation through the nanoporous support sheet 150, 152 is directly related to the hydrophilicity of the surfaces of the nanoporous support sheet 150, 152, the tortuosity of the pores in the nanoporous support sheet 150, 152, and the size of the pores in the nanoporous support sheet 150, 152. In particular, the inventors have found that pore size is particularly relevant, and that gas will neither form in the pores or migrate into the pores with a pore size that is about 100 nanometers (nm) or less. In an example, the largest pores in one or both of the nanoporous support sheets 150, 152 have a size of about 100 nm or less, for example about 95 nm or less, such as 90 nm or less, for example about 85 nm or less, such as about 80 nm or less, for example about 75 nm or less, such as about 70 nm or less, for example about 65 nm or less, such as 60 nm or less, for example about 55 nm or less, such as about 50 nm or less, for example about 45 nm or less, such as about 40 nm or less, for example about 35 nm or less, such as 30 nm or less, for example about 25 nm or less, such as about 20 nm or less, for example about 15 nm or less, such as about 10 nm or less.

When little or no gas becomes trapped in the pores of the nanoporous support sheets 150, 152, the nanoporous support sheets 150, 152 add very little overall resistance to the electrolyzer cell 100. For example, it was found that if little or no gas becomes trapped in the pores of a 100 μm thick nanoporous support sheet 150, 152, then the nanoporous support sheet 150, 152 introduces a resistance to the electrolyzer cell 100 that is comparable to a 100 μm gap between the electrode 112, 122 and the separator 131 that is filled with an alkaline electrolyte solution. In an example, the total thickness of the nanoporous support sheets 150, 152 is as thin as is practical to minimize the added resistance to the electrolyzer cell 100 by the inclusion of the nanoporous support sheets 150, 152. However, the nanoporous support sheets 150, 152 should also be thick enough to provide sufficient mechanical protection to the separator 131 from mechanical stresses due to the compressive load between the electrodes 112, 122 and the separator 131.

In an example, each nanoporous support sheet 150, 152 has a thickness of about 250 μm or less, for example about 240 μm or less, such as 230 μm or less, for example 225 μm or less, such as 220 μm or less, for example 210 μm or less, such as 200 μm or less, for example 195 μm or less, such as 190 μm or less, for example 185 μm or less, such as 180 μm or less, for example 175 μm or less, such as 170 μm or less, for example 165 μm or less, such as 160 μm or less, for example 155 μm or less, such as 150 μm or less, for example 145 μm or less, such as 140 μm or less, for example 135 μm or less, such as 130 μm or less, for example 125 μm or less, such as 120 μm or less, for example 115 μm or less, such as 110 μm or less, for example 105 μm or less, such as 100 μm or less, for example 95 μm or less, such as 90 μm or less, for example 85 μm or less, such as 80 μm or less, for example 75 μm or less, such as 70 μm or less, for example 65 μm or less, such as 60 μm or less, for example 55 μm or less, such as 50 μm or less, for example 45 μm or less, such as 40 μm or less, for example 35 μm or less, such as 30 μm or less, for example 25 μm or less, such as 20 μm or less, for example 15 μm or less, such as 10 μm or less. In an example, the thickness of the anode-side nanoporous support sheet 150 is the same as the thickness of the cathode-side nanoporous support sheet 152, e.g., so that if the total thickness of the nanoporous support sheets 150, 152 is about 200 μm, then the thickness of the anode-side nanoporous support sheet 150 is about 100 μm and the thickness of the cathode-side nanoporous support sheet 152 is also about 100 μm.

In an example, the one or more nanoporous support sheets 150, 152 can be added to the electrolyzer cell 100 as individual sheets. For example, the anode-side nanoporous support sheet 150 can be placed over the anode 112, then the separator 131 can be placed over the anode-side nanoporous support sheet 150. The cathode-side nanoporous support sheet 152 can then be placed over the separator 131, and finally the cathode 122 can be placed over the cathode-side nanoporous support sheet 152. Alternatively, an integrated multi-layered structure could be fabricated, for instance, by laminating a nanoporous support sheet 150, 152 on one or both faces of the separator 131. Laminating of one or more of the nanoporous support sheets 150, 152 and the separator 131 can be implemented using any of several common processes, such as using a dynamic reel to reel process, or a static process using a heated press.

### Example

Various embodiments of the present invention can be better understood by reference to the following Example which is offered by way of illustration. The present invention is not limited to the Example given herein.

120 μm thick sheets of polyethersulfone (PES) having 30 nm pores was tested in a laboratory-scale electrolyzer cell. The resulting voltage polarization curve was linear up to the maximum applied current density of 3 A/cm2. The cell voltage with two of the 120 μm thick PES sheets (e.g., a first 120 μm thick nanoporous PES sheet between the separator and the anode and a second 120 μm thick nanoporous PES sheet between the separator and the cathode) was approximately 800 mV higher than the same cell configuration without the nanoporous PES support sheets. It is expected that the voltage drop across the support sheets will scale with thickness. The inventors believe that there is no technical barrier to producing substantially thinner nanoporous support sheets (e.g., as thin as 25 μm thick) in the sizes required to work in a commercial electrolyzer cell. Everything else being equal, if two 25 μm thick nanoporous support sheets are used, the total expected voltage increase would be roughly 170 mV versus the voltage across an equivalent cell without the nanoporous support sheets. The separator lifetime could be increased dramatically, making the “cost” in increased voltage potentially worth paying. In practice, the optimal thickness of the nanoporous support sheets will balance the voltage cost against the increased mechanical robustness of the multi-layered structure (e.g., the separator 131 and one or both of the anode-side nanoporous support sheet 150 and the cathode-side nanoporous support sheet 152) compared to operation without the nanoporous support sheets.

### Additional Embodiments

The following exemplary embodiments are provided, the numbering of which is not to be construed as designating levels of importance. To illustrate the systems and methods disclosed in the present application, a non-limiting list of example Embodiments is provided here.

EMBODIMENT 1 can include subject matter (such as an apparatus, a device, a method, or one or more means for performing acts), such as can include an electrolyzer system comprising a first half cell with a first electrode, a second half cell with a second electrode, a separator separating the first half cell from the second half cell, wherein a compressive load is applied between the separator and the first electrode, or between the separator and the second electrode, or between both the first and second electrodes and the separator, and a first nanoporous support structure located between the first electrode and the separator.

EMBODIMENT 2 can include, or can optionally be combined with the subject matter of EMBODIMENT 1, to optionally include the first nanoporous support structure being configured to support or protect the separator from mechanical force exerted between the separator and the first electrode due to the compressive load.

EMBODIMENT 3 can include, or can optionally be combined with the subject matter of one or a combination of EMBODIMENT 1 and EMBODIMENT 2, to optionally include the first nanoporous support structure being no more than 200 micrometers thick.

EMBODIMENT 4 can include, or can optionally be combined with the subject matter of one or any combination of EMBODIMENTS 1-3, to optionally include the first nanoporous support structure being no more than 150 micrometers thick.

EMBODIMENT 5 can include, or can optionally be combined with the subject matter of one or any combination of EMBODIMENTS 1-4, to optionally include the first nanoporous support structure being no more than 125 micrometers thick.

EMBODIMENT 6 can include, or can optionally be combined with the subject matter of one or any combination of EMBODIMENTS 1-5, to optionally include the first nanoporous support structure being no more than 100 micrometers thick.

EMBODIMENT 7 can include, or can optionally be combined with the subject matter of one or any combination of EMBODIMENTS 1-6, to optionally include the first nanoporous support structure being no more than 50 micrometers thick.

EMBODIMENT 8 can include, or can optionally be combined with the subject matter of one or any combination of EMBODIMENTS 1-7, to optionally include the first nanoporous support structure being no more than 25 micrometers thick.

EMBODIMENT 9 can include, or can optionally be combined with the subject matter of one or any combination of EMBODIMENTS 1-8, to optionally include a pore size of the first nanoporous support structure being no more than 100 nanometers.

EMBODIMENT 10 can include, or can optionally be combined with the subject matter of one or any combination of EMBODIMENTS 1-9, to optionally include a pore size of the first nanoporous support structure being no more than 75 nanometers.

EMBODIMENT 11 can include, or can optionally be combined with the subject matter of one or any combination of EMBODIMENTS 1-10, to optionally include a pore size of the first nanoporous support structure being no more than 50 nanometers.

EMBODIMENT 12 can include, or can optionally be combined with the subject matter of one or any combination of EMBODIMENTS 1-11, to optionally include a pore size of the first nanoporous support structure being no more than 30 nanometers.

EMBODIMENT 13 can include, or can optionally be combined with the subject matter of one or any combination of EMBODIMENTS 1-12, to optionally include the first nanoporous support structure comprising a polymer material with pores formed therein.

EMBODIMENT 14 can include, or can optionally be combined with the subject matter of EMBODIMENT 13, to optionally include the polymer material comprising a hydrophilic polymer.

EMBODIMENT 15 can include, or can optionally be combined with the subject matter of EMBODIMENT 13, to optionally include the polymer material comprising a hydrophobic polymer.

EMBODIMENT 16 can include, or can optionally be combined with the subject matter of EMBODIMENT 13, to optionally include the polymer material comprising a blend of a hydrophilic polymer and a hydrophobic polymer.

EMBODIMENT 17 can include, or can optionally be combined with the subject matter of one or any combination of EMBODIMENTS 13-16, to optionally include the polymer material comprising a copolymer comprising hydrophilic blocks and hydrophobic blocks.

EMBODIMENT 18 can include, or can optionally be combined with the subject matter of one or any combination of EMBODIMENTs 13-17, to optionally include the polymer material comprising at least one of polytetrafluoroethylene (PTFE), polypropylene (PP), polyethersulfone (PES), polyphenylene sulfide (PPS), and polyphenyl sulfone (PPSU).

EMBODIMENT 19 can include, or can optionally be combined with the subject matter of one or any combination of EMBODIMENTS 1-18, to optionally include at least a portion of the surfaces of the first nanoporous support structure being hydrophilic.

EMBODIMENT 20 can include, or can optionally be combined with the subject matter of one or any combination of EMBODIMENTS 1-19, to optionally include the first nanoporous support structure being treated with a surface treatment to provide hydrophilicity.

EMBODIMENT 21 can include, or can optionally be combined with the subject matter of EMBODIMENT 20, to optionally include the surface treatment comprising at least one of plasma irradiation, ultraviolet light irradiation, corona discharge, ion assisted reaction (IAR), and application of a hydrophilic coating.

EMBODIMENT 22 can include, or can optionally be combined with the subject matter of one or any combination of EMBODIMENTS 1-21, to optionally include one or more first elastic elements configured to generate at least a portion of the compressive load.

EMBODIMENT 23 can include, or can optionally be combined with the subject matter of EMBODIMENT 22, to optionally include the one or more first elastic elements being positioned adjacent to the first electrode, wherein the portion of the compressive load generated by the one or more first elastic elements causes the first electrode to be compressed toward the separator.

EMBODIMENT 24 can include, or can optionally be combined with the subject matter of EMBODIMENT 23, to optionally include one or more second elastic elements configured to generate a second portion of the compressive load, wherein the one or more second elastic elements are positioned adjacent to the second electrode, wherein the second portion of the compressive load causes the second electrode to be compressed toward the separator.

EMBODIMENT 25 can include, or can optionally be combined with the subject matter of EMBODIMENT 22, to optionally include the one or more first elastic elements being positioned adjacent to the second electrode, wherein the portion of the compressive load generated by the one or more first elastic elements causes the second electrode to be compressed toward the separator.

EMBODIMENT 26 can include, or can optionally be combined with the subject matter of one or any combination of EMBODIMENTS 1-25, to optionally include a second nanoporous support structure located between the second electrode and the separator.

EMBODIMENT 27 can include, or can optionally be combined with the subject matter of EMBODIMENT 26, to optionally include the second nanoporous support structure being configured to support or protect the separator from mechanical force exerted between the second electrode and the separator due to the compressive load.

EMBODIMENT 28 can include, or can optionally be combined with the subject matter of one or a combination of EMBODIMENT 26 and EMBODIMENT 27, to optionally include the second nanoporous support structure being no more than 200 micrometers thick.

EMBODIMENT 29 can include, or can optionally be combined with the subject matter of one or any combination of EMBODIMENTS 26-28, to optionally include the second nanoporous support structure being no more than 150 micrometers thick.

EMBODIMENT 30 can include, or can optionally be combined with the subject matter of one or any combination of EMBODIMENTS 26-28, to optionally include the second nanoporous support structure being no more than 125 micrometers thick.

EMBODIMENT 31 can include, or can optionally be combined with the subject matter of one or any combination of EMBODIMENTS 26-30, to optionally include the second nanoporous support structure being no more than 100 micrometers thick.

EMBODIMENT 32 can include, or can optionally be combined with the subject matter of one or any combination of EMBODIMENTS 26-31, to optionally include the second nanoporous support structure being no more than 50 micrometers thick.

EMBODIMENT 33 can include, or can optionally be combined with the subject matter of one or any combination of EMBODIMENTS 26-32, to optionally include the second nanoporous support structure being no more than 25 micrometers thick.

EMBODIMENT 34 can include, or can optionally be combined with the subject matter of one or any combination of EMBODIMENTS 26-33, to optionally include a pore size of the second nanoporous support structure being no more than 100 nanometers.

EMBODIMENT 35 can include, or can optionally be combined with the subject matter of one or any combination of EMBODIMENTS 26-34, to optionally include a pore size of the second nanoporous support structure being no more than 75 nanometers.

EMBODIMENT 36 can include, or can optionally be combined with the subject matter of one or any combination of EMBODIMENTS 26-35, to optionally include a pore size of the second nanoporous support structure being no more than 50 nanometers.

EMBODIMENT 37 can include, or can optionally be combined with the subject matter of one or any combination of EMBODIMENTS 26-36, to optionally include a pore size of the second nanoporous support structure being no more than 30 nanometers.

EMBODIMENT 38 can include, or can optionally be combined with the subject matter of one or any combination of EMBODIMENTS 26-37, to optionally include the second nanoporous support structure comprising a polymer material with pores formed therein.

EMBODIMENT 39 can include, or can optionally be combined with the subject matter of EMBODIMENT 38, to optionally include the polymer material of the second nanoporous support structure comprising a hydrophilic polymer.

EMBODIMENT 40 can include, or can optionally be combined with the subject matter of EMBODIMENT 38, to optionally include the polymer material of the second nanoporous support structure comprising a hydrophobic polymer.

EMBODIMENT 41 can include, or can optionally be combined with the subject matter of EMBODIMENT 38, to optionally include the polymer material of the second nanoporous support structure comprising a blend of a hydrophilic polymer and a hydrophobic polymer.

EMBODIMENT 42 can include, or can optionally be combined with the subject matter of one or any combination of EMBODIMENTS 38-41, to optionally include the polymer material of the second nanoporous support structure comprising a copolymer comprising hydrophilic blocks and hydrophobic blocks.

EMBODIMENT 43 can include, or can optionally be combined with the subject matter of one or any combination of EMBODIMENTS 38-42, to optionally include the polymer material of the second nanoporous support structure comprising at least one of polytetrafluoroethylene (PTFE), polypropylene (PP), polyethersulfone (PES), polyphenylene sulfide (PPS), and polyphenyl sulfone (PPSU).

EMBODIMENT 44 can include, or can optionally be combined with the subject matter of one or any combination of EMBODIMENTS 26-43, to optionally include at least a portion of the surfaces of the second nanoporous support structure being hydrophilic.

EMBODIMENT 45 can include, or can optionally be combined with the subject matter of one or any combination of EMBODIMENTS 26-44, to optionally include the second nanoporous support structure being treated with a surface treatment to provide hydrophilicity.

EMBODIMENT 46 can include, or can optionally be combined with the subject matter of EMBODIMENT 45, to optionally include the surface treatment of the second nanoporous support structure comprising at least one of plasma irradiation, ultraviolet light irradiation, corona discharge, ion assisted reaction (IAR), and application of a hydrophilic coating.

EMBODIMENT 47 can include, or can optionally be combined with the subject matter of one or any combination of EMBODIMENTS 1-46, to include subject matter (such as an apparatus, a device, a method, or one or more means for performing acts), such as can include a method of manufacturing an electrolyzer cell, the method comprising the steps of providing or receiving a first electrode, a second electrode, and a separator, positioning a first nanoporous support structure between the first electrode and the separator, positioning the second electrode relative to the separator, and applying a compressive load between the separator and the first electrode, or between the separator and the second electrode, or between the first and second electrodes and the separator.

EMBODIMENT 48 can include, or can optionally be combined with the subject matter of EMBODIMENT 47, to optionally include the first nanoporous support structure being configured to support or protect the separator from mechanical force exerted between the first electrode and the separator due to the compressive load.

EMBODIMENT 49 can include, or can optionally be combined with the subject matter of one or a combination of EMBODIMENT 47 and EMBODIMENT 48, to optionally include the first nanoporous support structure being no more than 200 micrometers thick.

EMBODIMENT 50 can include, or can optionally be combined with the subject matter of one or any combination of EMBODIMENTS 47-49, to optionally include the first nanoporous support structure being no more than 150 micrometers thick.

EMBODIMENT 51 can include, or can optionally be combined with the subject matter of one or any combination of EMBODIMENTS 47-50, to optionally include the first nanoporous support structure being no more than 125 micrometers thick.

EMBODIMENT 52 can include, or can optionally be combined with the subject matter of one or any combination of EMBODIMENTS 47-51, to optionally include the first nanoporous support structure being no more than 100 micrometers thick.

EMBODIMENT 53 can include, or can optionally be combined with the subject matter of one or any combination of EMBODIMENTS 47-52, to optionally include the first nanoporous support structure being no more than 50 micrometers thick.

EMBODIMENT 54 can include, or can optionally be combined with the subject matter of one or any combination of EMBODIMENTS 47-53, to optionally include the first nanoporous support structure being no more than 25 micrometers thick.

EMBODIMENT 55 can include, or can optionally be combined with the subject matter of one or any combination of EMBODIMENTS 47-54, to optionally include a pore size of the first nanoporous support structure being no more than 100 nanometers.

EMBODIMENT 56 can include, or can optionally be combined with the subject matter of one or any combination of EMBODIMENTS 47-55, to optionally include a pore size of the first nanoporous support structure being no more than 75 nanometers.

EMBODIMENT 57 can include, or can optionally be combined with the subject matter of one or any combination of EMBODIMENTS 47-56, to optionally include a pore size of the first nanoporous support structure being no more than 50 nanometers.

EMBODIMENT 58 can include, or can optionally be combined with the subject matter of one or any combination of EMBODIMENTS 47-57, to optionally include a pore size of the first nanoporous support structure being no more than 30 nanometers.

EMBODIMENT 59 can include, or can optionally be combined with the subject matter of one or any combination of EMBODIMENTS 47-58, to optionally include surface treating the first nanoporous support structure to provide hydrophilicity.

EMBODIMENT 60 can include, or can optionally be combined with the subject matter of EMBODIMENT 59, to optionally include the surface treating comprising at least one of plasma irradiation, ultraviolet light irradiation, corona discharge, ion assisted reaction (IAR), and applying a hydrophilic coating onto the first nanoporous support structure.

EMBODIMENT 61 can include, or can optionally be combined with the subject matter of one or any combination of EMBODIMENTS 47-60, to optionally include the first nanoporous support structure comprising a polymer material with pores formed therein.

EMBODIMENT 62 can include, or can optionally be combined with the subject matter of EMBODIMENT 61, to optionally include the polymer material of the first nanoporous support structure comprising a hydrophilic polymer.

EMBODIMENT 63 can include, or can optionally be combined with the subject matter of EMBODIMENT 61, to optionally include the polymer material of the first nanoporous support structure comprising a hydrophobic polymer.

EMBODIMENT 64 can include, or can optionally be combined with the subject matter of EMBODIMENT 61, to optionally include the polymer material of the first nanoporous support structure comprising a blend of a hydrophilic polymer and a hydrophobic polymer.

EMBODIMENT 65 can include, or can optionally be combined with the subject matter of one or any combination of EMBODIMENTS 61-64, to optionally include the polymer material of the first nanoporous support structure comprising a copolymer comprising hydrophilic blocks and hydrophobic blocks.

EMBODIMENT 66 can include, or can optionally be combined with the subject matter of one or any combination of EMBODIMENTS 61-65, to optionally include the polymer material of the first nanoporous support structure comprising at least one of polytetrafluoroethylene (PTFE), polypropylene (PP), polyethersulfone (PES), polyphenylene sulfide (PPS), and polyphenyl sulfone (PPSU).

EMBODIMENT 67 can include, or can optionally be combined with the subject matter of one or any combination of EMBODIMENTS 47-66, to optionally include at least a portion of the surfaces of the first nanoporous support structure being hydrophilic.

EMBODIMENT 68 can include, or can optionally be combined with the subject matter of one or any combination of EMBODIMENTS 47-67, to optionally include positioning one or more first elastic elements adjacent to the first electrode, wherein the one or more first elastic elements generate at least a portion of the compressive load, wherein the portion of the compressive load generated by the one or more first elastic elements causes the first electrode to be compressed toward the separator.

EMBODIMENT 69 can include, or can optionally be combined with the subject matter of EMBODIMENT 68, to optionally include positioning one or more second elastic elements adjacent to the second electrode, wherein the one or more second elastic elements generate at least a second portion of the compressive load, wherein the second portion of the compressive load generated by the one or more second elastic elements causes the second electrode to be compressed toward the separator

EMBODIMENT 70 can include, or can optionally be combined with the subject matter of one or any combination of EMBODIMENTS 47-69, to optionally include positioning one or more elastic elements adjacent to the second electrode, wherein the one or more elastic elements generate at least a portion of the compressive load, wherein the portion of the compressive load generated by the one or more elastic elements causes the second electrode to be compressed toward the separator.

EMBODIMENT 71 can include, or can optionally be combined with the subject matter of one or any combination of EMBODIMENTS 47-70, to optionally include positioning a second nanoporous support structure between the second electrode and the separator.

EMBODIMENT 72 can include, or can optionally be combined with the subject matter of EMBODIMENT 71, to optionally include the second nanoporous support structure being configured to support or protect the separator from mechanical force exerted between the second electrode and the separator due to the compression load.

EMBODIMENT 73 can include, or can optionally be combined with the subject matter of one or any combination of EMBODIMENT 71 and EMBODIMENT 72, to optionally include surface treating the second nanoporous support structure to provide hydrophilicity.

EMBODIMENT 74 can include, or can optionally be combined with the subject matter of EMBODIMENT 73, to optionally include the surface treating comprising at least one of plasma irradiation, ultraviolet light irradiation, corona discharge, ion assisted reaction (IAR), and applying a hydrophilic coating onto the second nanoporous support structure.

EMBODIMENT 75 can include, or can optionally be combined with the subject matter of one or any combination of EMBODIMENTS 71-74, to optionally include to optionally include the second nanoporous support structure being no more than 200 micrometers thick.

EMBODIMENT 76 can include, or can optionally be combined with the subject matter of one or any combination of EMBODIMENTS 71-75, to optionally include the second nanoporous support structure being no more than 150 micrometers thick.

EMBODIMENT 77 can include, or can optionally be combined with the subject matter of one or any combination of EMBODIMENTS 71-76, to optionally include the second nanoporous support structure being no more than 125 micrometers thick.

EMBODIMENT 78 can include, or can optionally be combined with the subject matter of one or any combination of EMBODIMENTS 71-77, to optionally include the second nanoporous support structure being no more than 100 micrometers thick.

EMBODIMENT 79 can include, or can optionally be combined with the subject matter of one or any combination of EMBODIMENTS 71-78, to optionally include the second nanoporous support structure being no more than 50 micrometers thick.

EMBODIMENT 80 can include, or can optionally be combined with the subject matter of one or any combination of EMBODIMENTS 71-79, to optionally include the second nanoporous support structure being no more than 25 micrometers thick.

EMBODIMENT 81 can include, or can optionally be combined with the subject matter of one or any combination of EMBODIMENTS 71-80, to optionally include a pore size of the second nanoporous support structure being no more than 100 nanometers.

EMBODIMENT 82 can include, or can optionally be combined with the subject matter of one or any combination of EMBODIMENTS 71-81, to optionally include a pore size of the second nanoporous support structure being no more than 75 nanometers.

EMBODIMENT 83 can include, or can optionally be combined with the subject matter of one or any combination of EMBODIMENTS 71-82, to optionally include a pore size of the second nanoporous support structure being no more than 50 nanometers.

EMBODIMENT 84 can include, or can optionally be combined with the subject matter of one or any combination of EMBODIMENTS 71-83, to optionally include a pore size of the second nanoporous support structure being no more than 30 nanometers.

EMBODIMENT 85 can include, or can optionally be combined with the subject matter of one or any combination of EMBODIMENTS 71-84, to optionally include the second nanoporous support structure comprising a polymer material with pores formed therein.

EMBODIMENT 86 can include, or can optionally be combined with the subject matter of EMBODIMENT 85, to optionally include the polymer material of the second nanoporous support structure comprising a hydrophilic polymer.

EMBODIMENT 87 can include, or can optionally be combined with the subject matter of EMBODIMENT 85, to optionally include the polymer material of the second nanoporous support structure comprising a hydrophobic polymer.

EMBODIMENT 88 can include, or can optionally be combined with the subject matter of EMBODIMENT 85, to optionally include the polymer material of the second nanoporous support structure comprising a blend of a hydrophilic polymer and a hydrophobic polymer.

EMBODIMENT 89 can include, or can optionally be combined with the subject matter of one or any combination of EMBODIMENTS 85-88, to optionally include the polymer material of the second nanoporous support structure comprising a copolymer comprising hydrophilic blocks and hydrophobic blocks.

EMBODIMENT 90 can include, or can optionally be combined with the subject matter of one or any combination of EMBODIMENTS 85-89, to optionally include the polymer material of the second nanoporous support structure comprising at least one of polytetrafluoroethylene (PTFE), polypropylene (PP), polyethersulfone (PES), polyphenylene sulfide (PPS), and polyphenyl sulfone (PPSU).

EMBODIMENT 91 can include, or can optionally be combined with the subject matter of one or any combination of EMBODIMENTS 71-90, to optionally include at least a portion of the surfaces of the second nanoporous support structure being hydrophilic.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An electrolyzer cell comprising:
a first half cell with a first electrode;
a second half cell with a second electrode;
a separator separating the first half cell from the second half cell, wherein a compressive load is applied between the separator and the first electrode or between the separator and the second electrode, or between both the first and second electrodes and the separator; and
a first nanoporous support structure located between the first electrode and the separator.

2. The electrolyzer cell of claim 1, wherein the first nanoporous support structure is no more than 100 micrometers thick.

3. The electrolyzer cell of claim 1, wherein a pore size of the first nanoporous support structure is no more than 100 nanometers.

4. The electrolyzer cell of claim 1, wherein the first nanoporous support structure comprises a polymer material with pores formed therein.

5. The electrolyzer cell of claim 4, wherein the polymer material comprises a hydrophilic polymer, a hydrophobic polymer, a blend of a hydrophilic polymer and a hydrophobic polymer, or a copolymer comprising hydrophilic blocks and hydrophobic blocks.

6. The electrolyzer cell of claim 4, wherein the polymer material comprises at least one of polytetrafluoroethylene (PTFE), polypropylene (PP), polyethersulfone (PES), polyphenylene sulfide (PPS), and polyphenyl sulfone (PPSU).

7. The electrolyzer cell of claim 1, wherein at least a portion of surfaces of the first nanoporous support structure are hydrophilic.

8. The electrolyzer cell of claim 1, further comprising a second nanoporous support structure located between the second electrode and the separator.

9. The electrolyzer cell of claim 8, wherein the second nanoporous support structure is no more than 100 micrometers thick.

10. The electrolyzer cell of claim 8, wherein a pore size of the second nanoporous support structure is no more than 100 nanometers.

11. The electrolyzer cell of claim 1, further comprising an elastic element configured to generate at least a portion of the compressive load.

12. A method of manufacturing an electrolyzer cell, the method comprising:
providing or receiving a first electrode, a second electrode, and a separator;
positioning a first nanoporous support structure between the first electrode and the separator;
positioning the second electrode relative to the separator; and
applying a compressive load between the separator and the first electrode, or between the separator and the second electrode, or between both the first and second electrodes and the separator.

13. The method of claim 12, wherein the first nanoporous support structure is no more than about 100 micrometers thick.

14. The method of claim 12, wherein a pore size of the first nanoporous support structure is no more than about 100 nanometers.

15. The method of claim 12, further comprising surface treating the first nanoporous support structure to provide hydrophilicity.

16. The method of claim 15, wherein the surface treating comprises at least one of plasma irradiation, ultraviolet light irradiation, corona discharge, ion assisted reaction (IAR), and applying a hydrophilic coating onto the first nanoporous support structure.

17. The method of claim 12, further comprising positioning a second nanoporous support structure between the second electrode and the separator.

18. The method of claim 17, wherein a pore size of the second nanoporous support structure is no more than about 100 nanometers.

19. The method of claim 17, further comprising surface treating the second nanoporous support structure to provide hydrophilicity.

20. The method of claim 19, wherein the surface treating comprises at least one of plasma irradiation, ultraviolet light irradiation, corona discharge, ion assisted reaction (IAR), and applying a hydrophilic coating onto the second nanoporous support structure.
